(19) United States
(12) Patent Application Publication
(10) Pub. No.: US 2020/0324702 A1
(43) Pub. Date: Oct. 15, 2020

(54) REARVIEW DEVICE INTERCHANGEABLE BETWEEN ELECTRICAL REARVIEW MIRROR AND CONVENTIONAL REARVIEW MIRROR

(71) Applicants: FU DING PRECISION COMPONENT (SHEN ZHEN) CO., LTD., Shenzhen (CN); FOXCONN INTERCONNECT TECHNOLOGY LIMITED, Grand Cayman (KY)

(72) Inventor: YU-TAN LIEN, New Taipei (TW)

(21) Appl. No.: 16/845,908

(22) Filed: Apr. 10, 2020

(30) Foreign Application Priority Data
Apr. 10, 2019 (CN) 201910284227.6

(51) Int. Cl. B60R 1/12; B60R 1/04; B60R 11/04; H04N 5/225

(52) U.S. Cl. CPC B60R 1/12; B60R 1/04; B60R 2011/004; H04N 5/2253; H04N 5/22521; B60R 11/04

(57) ABSTRACT

An electronic rearview system includes an electronic rearview mirror connected with the internal car computer for displaying the surroundings of the car, a camera set transmitting the image data to the electronic rearview mirror, a sensor set detecting dirt, humidity or even damage of the camera set, and transmitting lines linked to the sensor for transmitting the corresponding detected data to the car computer to decide whether an action is required to be taken by switching the electronic rearview mirror to the conventional rearview mirror.

### BACKGROUND OF THE INVENTION

### 1. Field of the Invention

The present invention relates to a rearview device, and particularly to an automatic switchable digital rearview mirror.

### 2. Description of Related Arts

The conventional rear view mirror has a small angle of view, is easily obscured by blind spots, and fails to clear see the dark objects at night,thus easily causing false positives and safety accidents. Therefore, more and more new cars will be equipped with the electronic rearview mirror. The electronic rearview mirror can provide a wide viewing angle and eliminate the blind spots. The brightness can be adjusted according to different ambient light to provide a clear picture. However, because it is necessary to match the camera, when the camera is dirty or damaged, it will improperly block portions of the screen. Furthermore, when the screen is shot down, it will lose the function of the rear view mirror, thus causing greater danger when driving. China Utility Patent No. CN202271910U discloses the typical electronic rearview mirror which owns the aforementioned shortcomings.

Therefore, a rear view mirror device that can switch between the electronic and conventional mirror, wherein the mirror surface can not only simultaneously provide the functions/screens of the electronic rearview mirror, but also be converted into a conventional rearview mirror, if necessary, under some situations.

### SUMMARY OF THE INVENTION

To achieve the above object, an electronic rearview system includes a electronic rearview mirror connected with the internal car computer for displaying the surroundings of the car, a camera set transmitting the image data to the electronic rearview mirror, a sensor set detecting dirt, humidity or even damage of the camera set, and transmitting lines linked to the sensor for transmitting the corresponding detected data to the car computer to decide whether an action is required to be taken by switching the electronic rearview mirror to the conventional rearview mirror.

Other advantages and novel features of the invention will become more apparent from the following detailed description of the present embodiment when taken in conjunction with the accompanying drawings.

### BRIEF DESCRIPTION OF THE DRAWING

FIG. 1 is a rear view of a car equipped with the electronic rearview system according to the present invention;

FIG. 2 isa diagram of the electronic rearview system of FIG. 1; and

FIG. 3 shows the difference of the visible area/angle between the electronic rearview mirror and the conventional rearview mirror.

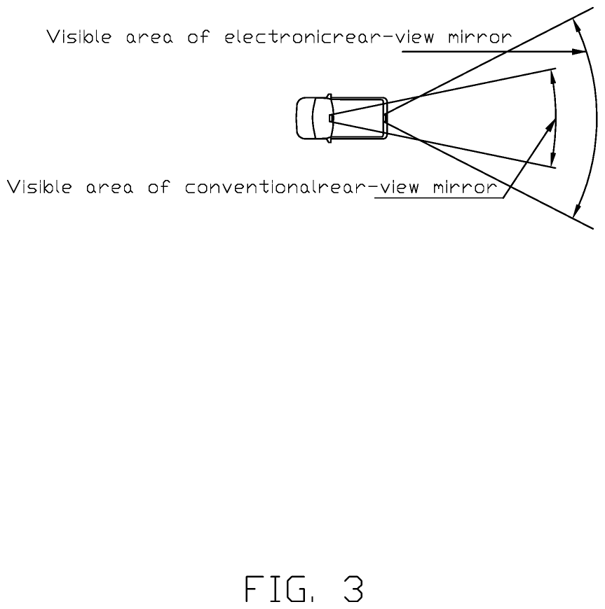

### DETAILED DESCRIPTION OF THE PREFERRED EMBODIMENT

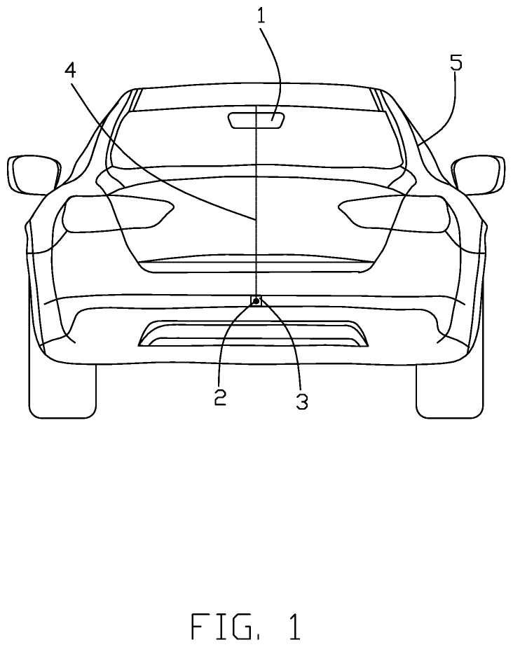

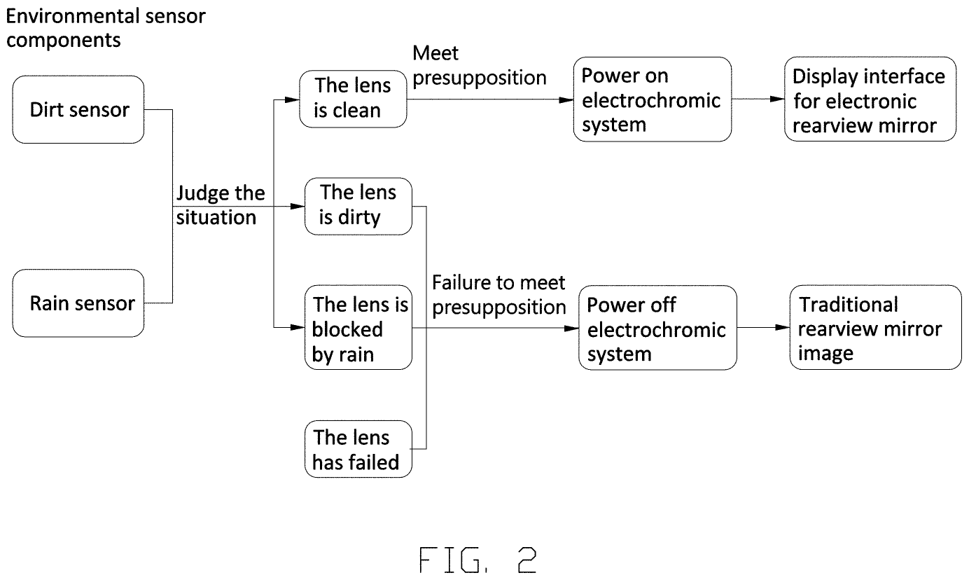

Referring to FIGS. 1-2, the electronic rearview system installed in the car, includes an electronic rearview mirror 1 located at the centerline of the car behind the windshield 5 and connected to an internal vehicle computer (not shown), a camera set 2 located at a tail of the car and rearwardly communicating with an exterior so as to transmit the corresponding image signal to the computer and/or the rearview mirror 1, a sensor set 3 adjacent to the camera set 2 to detect the respective conditions of the camera set 2 and pass the corresponding condition data to the computer and/or rearview mirror 1 so as to form an intelligent control with regard to the electronic rearview system.

Notably, the electronic rearview mirror 1 may increase the visible area/angle compared with the traditional mirror. The car further includes the side rearview mirrors (not labeled). Understandably, the car includes the turn signals and the backup light to which the electronic rearview mirror 1 may be electrically connected so as to enlarge the viewing area during those operations for assuring safety. Understandably, the camera set may surround the car rather than at the tail of the car.

The sensor set 3 is associatively located beside the corresponding camera set 1. The sensor set 3 includes the dust sensor and the humidity sensor to check the dust condition and the humidity condition of the camera set 2. The electronic rearview mirror 1 is performed by the electrochromic unit which is energized when the conditions of the camera set 2 are okay so as to display the picture captured by the camera set 2. In contrast, when the condition of the camera set 2 is not good enough by indication of the sensor set 3, the electrochromic unit is not energized and the rearview mirror 1 functions as the traditional/reflection type rearview mirror.

In this embodiment, the electronic rearview mirror includes the controller to receive the signals from the sensor set 3, either via the data line 4 or wireless, and pass the signals to the computer so as to allow the computer to decide whether the electronic rearview mirror is required to be switched to the traditional rearview mirror due to the bad conditions of the camera set 2.

Although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. An electronic rearview system comprising:
an electronic rearview mirror located behind a windshield of a car and equipped with electrochromic material;
a camera set located around a tail of the car; and
a sensor set located adjacent to the camera set to check camera conditions related to dust or humidity; wherein
the electronic rearview mirror displays a picture captured by the camera set via energizing the electrochromic material when the conditions are okay, or shows an image by reflection as a traditional rearview mirror via not energizing the electrochromic material when the conditions are not okay.

2. The electronic rearview system as claimed in claim 1, wherein the sensor set is connected to the rearview mirror, and the rearview mirror is connected to a computer to decide whether the electrochromic material is energized or not according to data collected by the sensor set.

3. The electrical rearview system as claimed in claim 1, wherein the sensor set is connected to the rearview mirror via a data line.

4. The electrical rearview system as claimed in claim 1, wherein the rearview mirror is electrically connected to a backup light or a directional signal.

5. The electrical rearview system as claimed in claim 1, wherein the electronic rearview mirror is located at a centerline of the car.

6. A method of operating an electronic rearview system, comprising steps of:
providing an electronic rearview mirror with electrochromic material;
providing a camera set at a tail of a car;
providing a sensor set beside the camera set to check conditions of the camera set related to either dirt or humidity; on the rearview mirror, displaying images captured by the camera set via energizing the electrochromic material when the conditions of the camera set are okay, or showing images directly reflectedthereby via not energizing the electrochromic material when the conditions of the camera set is not okay.

7. The method as claimed in claim 6, wherein the sensor set is connected to the rearview mirror, and the rearview mirror is connected to a computer to decide whether the electrochromic material is energized or not according to data collected by the sensor set.

8. The method as claimed in claim 6, wherein the sensor set is connected to the rearview mirror via a data line.

9. The method as claimed in claim 6, wherein the rearview mirror is electrically connected to a backup light or a directional signal.

10. The method as claimed in claim 6, wherein the electronic rearview mirror is located at a centerline of the car.

11. An electronic rearview system comprising:
an electronic rearview mirror equipped with electrochromic material;
a camera set located behind the electronic rearview mirror; and
a sensor set located adjacent to the camera set to check camera conditions related to dust or humidity; wherein
the electronic rearview mirror displays a picture captured by the camera set via energizing the electrochromic material when the conditions are okay, or shows an image by reflection as a traditional rearview mirror via not energizing the electrochromic material when the conditions are not okay.

12. The electronic rearview system as claimed in claim 11, wherein the sensor set is connected to the rearview mirror, and the rearview mirror is connected to a computer to decide whether the electrochromic material is energized or not according to data collected by the sensor set.

13. The electrical rearview system as claimed in claim 11, wherein the sensor set is connected to the rearview mirror via a data line.

14. The electrical rearview system as claimed in claim 11, wherein the rearview mirror is electrically connected to a backup light or a directional signal.

15. The electrical rearview system as claimed in claim 11, wherein the electronic rearview mirror is located at a centerline of the car.
